(19) United States
(12) Patent Application Publication
(10) Pub. No.: US 2014/0136350 A1
(43) Pub. Date: May 15, 2014

(54) SYSTEM AND METHOD FOR SECURE MOBILE CONTACTLESS PAYMENT

(71) Applicant: Risto K. Savolainen, London (GB)

(72) Inventor: Risto K. Savolainen, London (GB)

(21) Appl. No.: 14/079,882

(22) Filed: Nov. 14, 2013

Related U.S. Application Data
(60) Provisional application No. 61/726,121, filed on Nov. 14, 2012.

(51) Int. Cl. G06Q 20/20; G06Q 20/34; G06Q 20/32; G06K 19/073

(52) U.S. Cl. CPC G06Q 20/204; G06K 19/07336; G06Q 20/341; G06Q 20/3278
USPC 705/17; 235/492

(57) ABSTRACT

A point of sale terminal for facilitating payment transactions includes a network interface, a user interface, a short distance contactless radio frequency interface, and a universal integrated circuit card. The universal integrated circuit card includes at least one processor, at least one computer-readable tangible storage device, and program instructions stored on the at least one storage device for execution by the at least one processor. The program instructions include first program instructions configured to receive a data representative of payment en information via the user interface, the first payment information indicative of a request to initiate a payment transaction. The program instructions further include second program instructions configured to activate the short distance contactless radio frequency interface. The program instructions further include third program instructions configured to communicate and perform a payment transaction with a contactless card via the short distance contactless radio frequency interface to generate payment transaction information.

### CROSS-REFERENCE TO RELATED APPLICATIONS

This application claims priority from U.S. Provisional Patent Application No. 61/726,121, filed on Nov. 14, 2012, which is incorporated by reference herein in its entirety.

### BACKGROUND

Universal integrated circuit cards (“UICC card”), which are also referred to as smart a cards and chip cards, are commonly used as credit and debit cards. Chip cards store and process sensitive card and user information in a secured integrated circuit (“IC”), comprising a CPU, memory and contacts embedded in the credit card size plastic card. The CPU of the chip card can perform cryptographic operations to increase the security and reliability of a payment transaction. The user of a chip card can be required to enter a secret PIN code to confirm the authentication and presence of the card holder at the time of the transaction.

Credit and debit cards with a chip are commonly used around the world. For example, EMV, a global standard for chip payment cards (named after Europay, Mastercard and Visa) managed and owned by EMVCo Inc., is commonly used. The EMV standard is also used by EMV payment terminals, making them compatible with various EMV cards. EMV cards can communicate in both directions with EMV payment terminals either via physical contact interface as described in ISO 7816 standard, or via a Near Field Communication (hereinafter referred to as “NFC”) interface.

A UICC card, also used as a SIM card in the telecommunication industry, is a chip card with a specific software application used to authenticate the user to the cellular network. A UICC as a SIM card is standardized by ETSI (TS 102.221). The UICC card can be removed and inserted into another mobile phone and consequently the phone number will follow the UICC card. UICC cards can host multiple software applications that can communicate with the mobile phone and further with the network as described by ETSI standard (TS 102.223).

NFC is commonly used in a variety of applications, in one application, NFC is used to facilitate processing of payments by providing a short distance bi-directional data communication link, replacing the need for physical contact between a chip card and a chip card reader or the need for swiping the card through a magnetic stripe card reader. For example, an NFC equipped credit card can be placed within proximity of an NFC equipped payment terminal in order to make a payment. This eliminates the need to swipe the credit card and thus improves the speed and efficiency of processing a payment.

Mobile phones are commonly equipped with short distance communication technology such as NFC. Specifically, a UICC card of a NFC equipped phone is configured to support NFC functionality. This is implemented using a Single Wire Protocol (SWP) using the C6 connector as a physical connection between the NFC mobile phone and NFC UICC card. Thus, in one example, an NFC equipped credit card can be replaced with an NFC UICC card comprising the payment card information and credentials stored in its Secure Element (“SE”) and an NFC equipped mobile phone, together emulating a NFC card. This eliminates the need for carrying a credit card. Rather, an NFC equipped mobile phone that stores the credit card information in a Secure Element (SE) of the NFC UICC card's memory is placed within proximity of an NFC equipped payment terminal in order to make a payment.

In either example, however, an NFC equipped payment terminal or point of sale system is required to process the NFC card or NFC mobile phone payment. A payment terminal may not support NFC, however. Replacing an existing payment terminal with an NFC equipped payment terminal may not be feasible or cost effective. Thus, the benefits of making payments using NFC may not be fully realized.

### SUMMARY

A point of sale terminal for facilitating payment transactions includes a network interface, a user interface, a short distance contactless radio frequency interface, and a universal integrated circuit card. The integrated circuit card includes at least one processor, at least one computer-readable tangible storage device, and program instructions stored on the at least one storage device for execution by the at least one processor. The program instructions include first program instructions configured to receive a data representative of payment information via the user interface, the payment information indicative of a request to initiate a payment transaction. The program instructions further include second program instructions configured to activate the short distance contactless radio frequency interface. The program instructions further include third program instructions configured to communicate and perform a payment transaction with a contactless card via the short distance contactless radio frequency interface to generate payment transaction information. The program instructions further include fourth program instructions configured to determine that the generated payment transaction information is valid. The program instructions further include fifth program instructions configured to communicate the payment transaction information via the network interface.

A method for facilitating secure mobile contactless payments includes the step of receiving first payment information, the first payment information being indicative of a request to initiate a payment transaction. The method further includes the step of activating a short distance contactless radio frequency interface. The method further includes the step of receiving second payment information from the short distance contactless radio frequency interface. The method further includes the step of generating payment transaction information based on the first payment information and the second payment information. The method further includes the step of determining that the payment transaction information is valid. The method further includes the step of communicating the payment transaction information to a payment processing center.

A smart card for facilitating payment transactions in a hosting mobile computing device includes at least one processor, at least one computer-readable tangible storage device, and program instructions stored on the at least one storage device for execution by the at least one processor. The program instructions include first program instructions configured to receive a notification to initiate a payment transaction. The program instructions further include second program instructions configured to activate an NFC antenna. The program instructions further include third program instructions configured to receive data representative of first payment information via an interface of the hosting mobile computing device. The program instructions further include fourth program instructions configured to receive data representative of second payment information via the NFC antenna. The program instructions further include fifth program instructions configured to communicate data representative of a payment transaction comprising the first payment information and the second payment information.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an example secure contactless card and mobile contactless point of sale payment terminal system.

FIG. 2 is a block diagram of an example embodiment of a secure contactless point of sale payment terminal in an UICC/SIM card.

FIG. 3 is a block diagram of an example system for facilitating secure mobile contactless payments

FIG. 4 is a block diagram of another example system for facilitating secure mobile contactless payments

FIG. S is a block diagram of another example system for facilitating secure mobile contactless payments.

FIG. 6 is a flow chart illustrating an example method for facilitating secure mobile payments.

### DETAILED DESCRIPTION

The following includes definitions of selected terms employed herein. The definitions include various examples, forms, or both, of components that fall within the scope of a term and that may be used for implementation. The examples are not intended to be limiting. Both singular and plural forms of terms may be within the definitions.

“Mobile device,” as used herein, refers to a laptop computer, a desktop computer, a smartphone, a personal digital assistant, a cellular telephone, a mobile phone, a tablet computer, an eReader, a smart watch, a wearable computing device, or the like.

“Smart card,” as used herein, refers to a credit card or other similar type of payment card with an embedded integrated circuit (“IC”), comprising of a CPU, memory and contacts embedded in the card.

“UICC/SIM card,” as used herein, refers to a card with an embedded integrated circuit for storing identification used to identify a subscriber on a mobile telephone network.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, EEPROM memory, FLASH memory, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, JavaCard, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

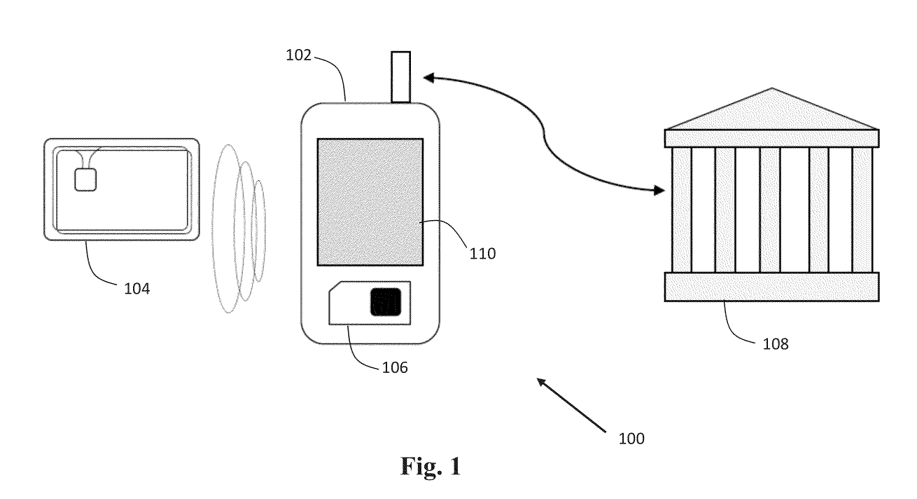

FIG. 1 illustrates an example secure mobile contactless payment system (hereinafter referred to as “the system”) 100. Mobile phone 102 includes a secure payment subscriber identity module Universal Integrated Circuit Card (hereinafter referred to as the “UICC/SIM” card) 106, which is configured to communicate via an NFC antenna (not shown), or a card reader interface, of mobile phone 102 wirelessly with an NFC enabled smartcard 104 in order to send to and receive payment information from the smartcard 104. The UICC/SIM card 106 is configured to store certificates, communicate, receive, process and request further information from and send payment information to a payment processing center 108 such as a bank. Thus, mobile phone 102 is configured to serve as a contactless card reader, a display and a communication channel. In combination with the UICC/SIM card 106, mobile phone 102 accepts payments without a need for a dedicated mobile payment terminal.

Sent payment information may be an EMV contactless card payment transaction or a proprietary contactless card payment transaction, for example. A payment transaction can be a prepaid, debit or credit card transaction or a fund transfer between two accounts. Once a transaction is complete, payment processing center 108 initiates, for example, a transfer of funds from the smartcard owner's account to mobile phone 102 owner's account or to another designated account.

The secure payment UICC/SIM card 106 is configured to communicate with payment processing center 108 using communication protocols available to mobile phone 102 such as TCP/IP, GPRS, CSD, SMS, USSD, and so on. In one example, secure payment UICC/SIM card 106 is configured to support off-line payments. For example, if mobile phone 102 is not able to communicate ate with payment processing center 108 at the time of a transaction, secure payment UICC/SIM card 106 is configured to store the processed payment information and to communicate the payment information to payment processing center 108 at a later time.

Mobile phone 102 includes a user interface 110 that is configured to enable a user to initiate a transaction. For example, UICC/SIM card 106 is configured to receive a transaction amount via user interface 110. Accordingly, secure payment UICC/SIM card 106 is configured to initiate a transaction and to communicate the transaction amount as well as the received payment information to payment processing center 108. User interface 110 can be a touch screen, a button or set of buttons, a microphone for receiving audio input, or any suitable interface for receiving a transaction amount or other relevant transaction information from a user.

In one example, a transaction may be initiated remotely by a source external of mobile phone 102. For example, mobile phone 102 is configured to receive a wireless notification of an amount to transact and pass it to the UICC/SIM card 106. Accordingly, secure payment UICC/SIM card 106 is configured to initiate a transaction and to communicate the received transaction amount as well as the received payment information to payment processing center 108. A transaction may be initiated remotely, for example, by a remote server, an online retail system, or other suitable system capable of communicating information wirelessly to mobile phone 102.

It should be understood that the mobile phone 102 may be similarly configured to wirelessly receive payment information from other NFC enabled devices suitable for communicating payment information. For example, mobile phone 102 maybe be configured to communicate with and receive payment information from a mobile computing device such as a smartphone or tablet.

in one example, mobile phone 102 is configured to receive payment information via an external device. For example, mobile phone 102 is configured to interface with an external card reader via an input such as a headphone connector, a USB or micro USB connector, a short distance wireless interface such as NFC, or via any suitable external connector of mobile phone 102. The external card reader (not shown) can include a magnetic strip reader, a contact or contactless card reader, or any reader suitable for receiving payment information. Accordingly, secure mobile UICC/SIM card 106 is configured to initiate a transaction and communicate externally received payment information to payment processing center 108 along with a received transaction amount.

it should be understood that although the examples illustrated herein refer to a mobile phone, any suitable computing device may be used such as laptop computer, a desktop computer, a tablet computer, a personal digital assistant, a game console, a portable music player, an automotive board computer, a digital camera, a card payment terminal, a satellite positioning or navigation device, a digital wallet, a smartphone, and so on.

It should be further understood that although the examples illustrated herein refer to a SIM card, a UICC card or other similar secure integrated circuit may be used.

It should be further understood that UICC/SIM card 106 may be either removable or fixed to the mobile phone 102.

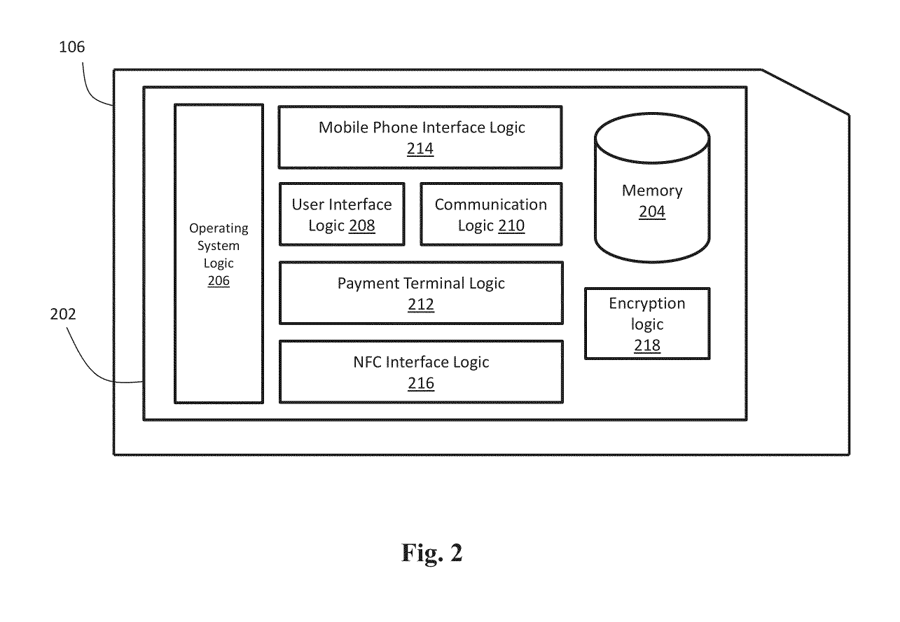

FIG. 2 illustrates a block diagram of an example secure payment UICC/SIM card 106 fur facilitating secure payment transactions. Secure payment UICC/SIM card 106 includes a processor 202 for executing instructions in a secured system on chip environment. The processor includes non-volatile memory 204 configured to store software, certificates, encryption keys, and encryption logic, for example. When payment transaction processing takes place either in processor 202 or in a processor of smartcard 104, but not in the mobile phone processor, the transaction can be verified and secured from end-to-end using the stored certificates, encryption keys, and encryption logic. Certificates and encryption keys can be managed independently and securely over-the-air (OTA) using suitable SIM card management methods or by connecting the secure payment UICC/SIM card 106 to a card reader. A certificate may be, for example, a Payment Acquirer Bank certificate, a Payment Card Scheme certificate, a Payment Receiver certificate, a telecommunication service provider certificate, or a network operator certificate.

The processor 202 also includes operating system logic 206 configured to facilitate execution of and provide resources to applications and other instructions or program logic within secure payment UICC/SIM card 106. In one example, operating system logic 206 comprises Java Card.

Secure payment UICC/SIM card 106 can facilitate mobile payment transactions by a mobile phone 102 by implementing a payment terminal as a software application stored in and executed by processor 202. Specifically, a mobile payment software application includes user interface logic 208, communication logic 210, and payment terminal logic 212.

User interface logic 208 is configured to receive information from and provide information to a user via user interface 110, including receiving information from a keypad or a touchpad, communicating information to and from a display, and so on. For example, user interface logic 208 is configured to initiate a payment transaction in response to receiving appropriate user input. User input for initiating a payment transaction may include clicking a button, touching an icon, speaking a voice command, and so on. For example, a user may touch an icon for an app using user interface 110 that would indicate to user interface logic 208 that the user intends to initiate a payment transaction. Accordingly, user interface logic 208 is configured to render payment processing instructions to user interface 110 in order to receive additional information from the user such as the amount of the payment to be processed.

User interface logic 208 is configured to communicate information to a user interface 110 in the form of text, graphics, audio, video, or any suitable form or user interface output, or any combination thereof. In one example, user interface logic 208 is configured to communicate a request, to user interface 110, for additional information in order to process a payment transaction. For example, user interface logic 208 may communicate a request for a pin code. Similarly, user interface logic 208 is configured to receive information from a user interface 110 in the form of text, graphics, audio, video, or any suitable form or user interface input, or any combination thereof.

Mobile phone interface logic 214 is configured to facilitate communication between user interface logic 208 and user interface 110. Specifically, mobile phone interface logic 214 enables mobile payment software implemented by mobile phone 102 to leverage the available hardware components of the mobile phone 102 such as the display, the keypad, and so on. In one example, mobile phone interface logic 214 is implemented using secure API such as Java JSR 177 or JSR 248 or Open Mobile API. In another example, mobile phone interface logic 214 is implemented using SIM Toolkit.

NFC interface logic 216 configured to provide a communication interface between secure payment UICC/SIM card 106 and an NFC chip or NFC antenna (not shown) on mobile phone 102. This enables the secure payment UICC/SIM card 106 to communicate payment information via the mobile phone's 102 NFC chip and antenna. In one example, NFC interface logic 216 comprises a Single Wire Protocol (SWP) interface.

Payment terminal logic 212 is configured to activate the NFC chip (not shown) via NFC interface logic 216. Specifically, payment terminal logic is configured to activate an NFC loop antenna (not shown), or other similar interface, in mobile phone 102, in response to user interface logic 208 receiving a notification of a user's intention to initiate a payment transaction, in order to transmit a signal that powers up an NFC-enabled smart card 104 or an NFC-enabled computing device. Payment terminal logic 212 is further configured to wait until a smartcard 104 is placed within proximity of the NFC loop antenna in order to establish communication with the smartcard 104 via NFC interface logic 216.

Payment terminal logic 212 is further configured to send payment en information to and receive payment information from smartcard 104 via NFC interface logic when the NFC loop antenna is active and when smartcard 104 is within range. Payment terminal logic 212 is further configured to communicate with encryption logic 218 to process and encrypt payment information using a secure key stored in memory 204.

Communication logic 210 is configured to communicate payment transaction information, including payment amount received from a user via user interface logic 208 and payment information received from a smartcard via NFC interface logic 216, to payment processing center 108. Communication logic 210 is configured to utilize any suitable communication protocols available to mobile phone 102 for communicating the payment transaction information. For example, communication logic 210 may communicate the payment transaction information to payment processing center using TCP/IP, GPRS, CSD, SMS, USSD, and so on.

In one example, communication logic 210 is further configured to receive instructions from a remote server to initiate a payment transaction. In such an example, payment terminal logic is configured to communicate with the user interface logic to request for a confirmation from the user and to activate an NFC loop antenna in mobile phone 102, in response to communication logic 210 receiving a notification to initiate a payment transaction.

It should be understood that the user interface logic 208, communication logic 210 and payment terminal logic 212 described herein may implemented as hardware or software or a combination of hardy are and software. It should be further understood that user interface logic 208, communication logic 210, and payment terminal logic 212 may be implemented in a secure element (not shown) embedded in a circuit board of a mobile phone.

In one example, payment terminal logic 212 is configured to determine a current physical location based on information from a network, a mobile device, a geo-location system such as a GPS receiver, or using other suitable methods for determining a current location. Payment terminal logic 212 is further configured to either accept or reject a transaction based on a determined current location. For example, secure payment UICC/SIM card 106 may store in memory 204 information of approved locations. Or, secure payment UICC/SIM card 106 may request approval from a network. If the current location is determined to be an approved location, payment terminal logic 212 is configured to approve the transaction or allow the transaction to proceed. In one example, user interface logic 208 is configured to communicate a different message to a user via user interface 110 depending on whether the current location is determined to be an approved location. For example, a user interface 110 may display a message that says “Warning: this terminal is outside if its approved working area” when a current location is determined not to be an approved location. In addition, payment terminal logic 212 is configured to reject the payment transaction.

In one example, payment terminal logic 212 is configured to determine the identity of a host mobile device in which secure payment UICC/SIM card 106 is inserted. Payment terminal logic 212 can be configured to perform an identity check when the mobile phone or the UICC/SIM card is powered on or when a payment transaction is initiated, for example. In one example, the secure payment UICC/SIM card 106 may be paired with or locked in to only function with one or more particular approved mobile phones, based on a unique identification of the mobile phone. Accordingly, if secure payment UICC/SIM card 106 is removed from the paired mobile phone and inserted into a new mobile phone or device, payment terminal logic 212 is configured to detect a change in host device. In one example, when a new host device is detected, payment terminal logic 212 is configured to stop working. In another example, payment terminal logic 212 is configured to continue to function normally. In another example, payment terminal logic 212 is configured to require a new pairing with the new device. In one example, payment terminal logic 212 is configured to report the new host device or send out an alert.

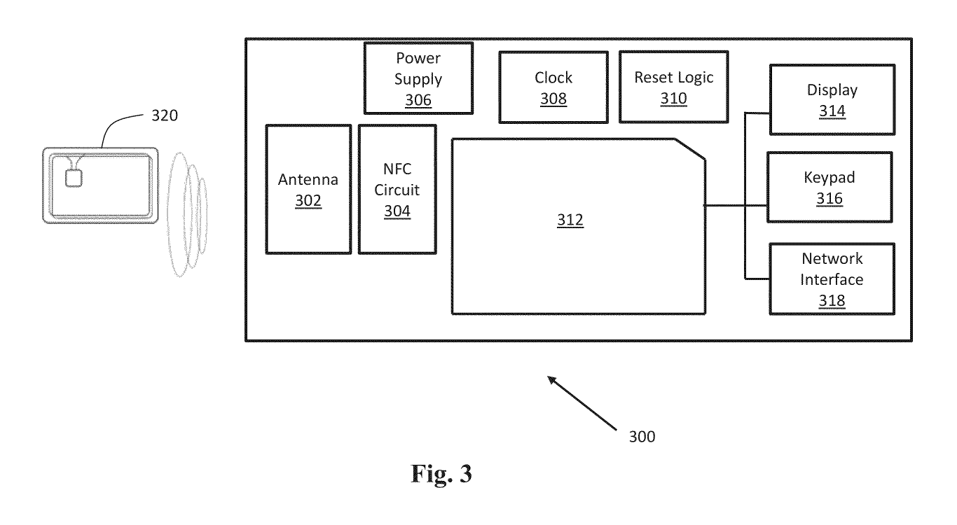

FIG. 3 is a block diagram of an example mobile phone 300 for facilitating secure mobile payments. Mobile phone 300 includes an NFC loop antenna 302 and an NFC circuit 304 for communicating with an NFC-enabled smartcard 320. Mobile phone also includes a power supply 306, a clock 308, and reset logic 310.

Mobile phone 300 includes a secure payment SIM card 312 for facilitating mobile payment transactions. In this example, all payment processing, interface, and communication logic is embedded in secure payment SIM card 312. Secure payment SIM card 312 communicates with display 314, keypad 316, and network interface 318 directly via mobile phone interface logic such as a Java API.

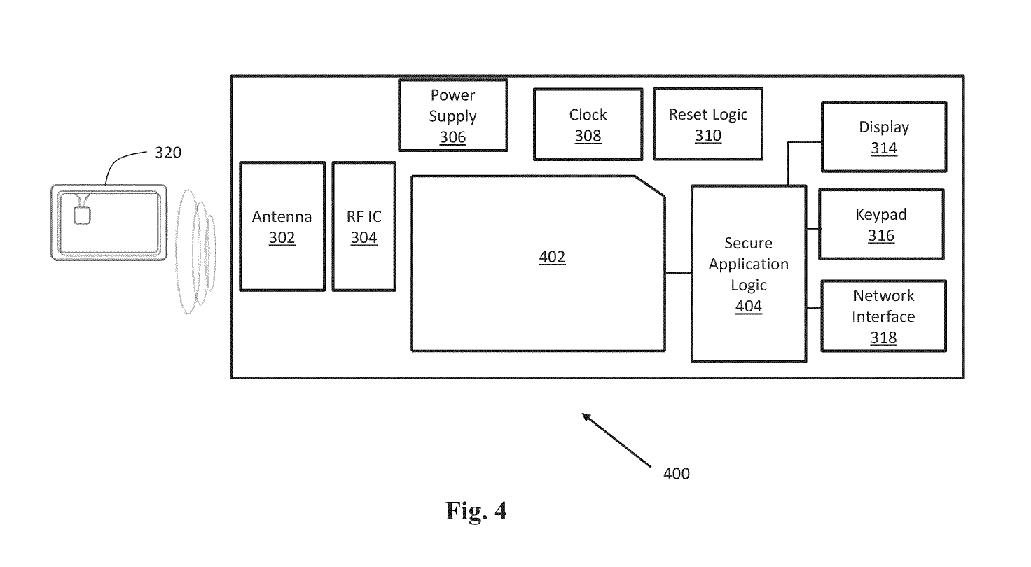

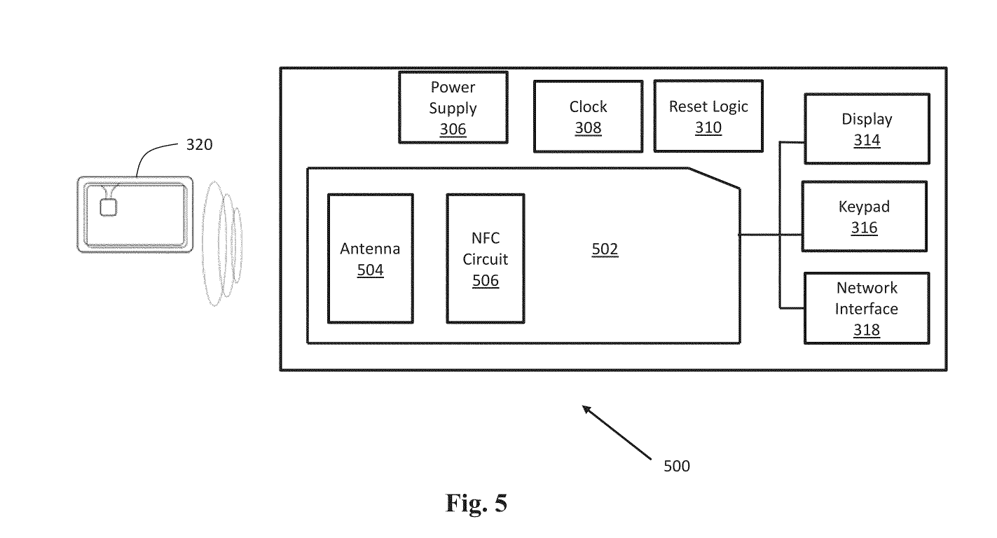

FIG. 4 is a block diagram of another example mobile phone 400 for facilitating secure mobile payments. In the example illustrated, a portion of the user interface logic is removed from the secure payment SIM card 402 and implemented inside device memory of mobile phone 400. In particular, mobile phone 400 includes a secure application logic 404 configured to interface with display 314, keypad 316, and network interface 318. Secure application logic 404 provides for increased user interface functionality while maintaining secure communication with the SIM card 402 within mobile phone 400. For example, secure application logic 404 enables secure payment SIM card 402 to provide a user with increased levels of graphics that may otherwise not be available to secure payment SIM card via a Java API or SIM Toolkit.

It should be understood that although the example illustrates secure payment SIM card 402 communicating with display 314, keypad, 316, and network access 318 via secure application logic 404, secure payment SIM card 402 may communicate with one or two of display 314, keypad 316, and network access 318 via secure application logic 404 while communicating with one or two of display 314, keypad 316, and network access 318 via interface logic such as Java API or SIM Toolkit. For example, secure payment SIM card 402 may communicate with display 314 via secure application logic 404 while communicating with keypad 316 and network access 318 directly via interface logic such as Java API or SIM Toolkit.

FIG. 5 is a block diagram of another example mobile phone 500 for facilitating secure mobile payments. In this example, secure payment SIM card 502 includes an NFC loop antenna 502 and an NFC circuit 504 for communicating with an NFC-enabled smartcard 320. Thus, a mobile phone 500 may be configured to facilitate mobile payments, even if mobile phone 500 does not have built-in NFC capabilities.

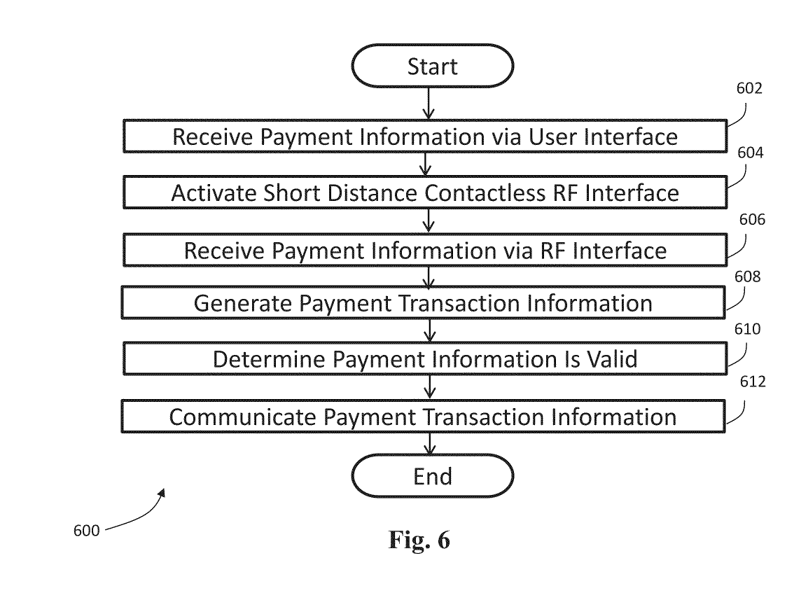

FIG. 6 is a flow chart illustrating an example method for facilitating secure mobile payments. At step 602, a secure payment UICC/SIM card 106 receives payment information via user interface 110. The payment information is indicative of a request to initiate a payment transaction. At step 604, the secure payment UICC/SIM card 106 activates a short distance contactless radio frequency interface to communicate with an NFC-enabled smartcard or other NFC-enabled device. At step 606, the secure payment UICC/SIM card 106 receives payment information, including a credit or debit card number, via the short distance contactless radio frequency interface. At step 608, the secure payment UICC/SIM card 106 generates payment transaction information. At step 610, the secure payment UICC/SIM card 106 determines that the payment transaction information is valid. In one example, the secure payment UICC/SIM card 106 determines that the payment transaction information is valid by communicating a request to a payment processing center to validate the payment transaction information. At step 612, the secure payment UICC/SIM card 106 communicates the payment transaction information to a payment processing center.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. A point of sale terminal for facilitating payment transactions comprising:
a network interface;
a user interface;
a short distance contactless radio frequency interface; and
a universal integrated circuit card comprising at least one processor, at least one computer-readable tangible storage device, and program instructions stored on the at least one storage device for execution by the at least one processor, the program instructions comprising:
first program instructions configured to receive a data representative of payment information via the user interface, the payment information indicative of a request to initiate a payment transaction;
second program instructions configured to activate the short distance contactless radio frequency interface;
third program instructions configured to communicate and perform a payment transaction with a contactless card via the short distance contactless radio frequency interface to generate payment transaction information;
fourth program instructions configured to determine that the generated payment transaction information is valid; and
fifth program instructions configured to communicate the payment transaction information via the network interface.

2. The point of sale terminal of claim 1, the program instructions further comprising sixth program instructions configured to encrypt the payment transaction information.

3. The point of sale terminal of claim 1, wherein the integrated circuit card comprises at least one of a UICC card, a USIM card, a SIM card, and a RSIM card.

4. The point of sale terminal of claim 1, wherein the integrated circuit card is coupled to the short distance contactless radio frequency interface by Single Wire Protocol.

5. The point of sale terminal of claim 1, wherein the integrated circuit card is removable.

6. The point of sale terminal of claim 1, wherein the integrated circuit card is fixed.

7. The point of sale terminal of claim 1, wherein the short, distance contactless interface is a Near Field Communication interface.

8. The point of sale I of claim 1, the program instructions further comprising sixth program instructions configured to store data representative of a payment transaction for future processing.

9. The point of sale terminal of claim l, the program instructions further comprising sixth program instructions configured to communicate a request, to the user interface, for additional information.

10. The point of sale system of claim 1, wherein the fourth program instructions configured to determine that the generated payment transaction information is valid comprises the fourth program instructions communicating a request to a payment processing center to validate the payment transaction information.

11. The point of sale terminal of claim 1, wherein fourth program instructions configured to determine that the received second payment information is valid for a payment transaction by verifying a stored certificate.

12. The point of sale terminal of claim 10, wherein the certificate comprises at least one of a Payment Acquirer Bank certificate, a Payment Card Scheme certificate, a Payment Receiver certificate, a telecommunication service provider certificate, and a network operator certificate.

13. The point of sale terminal of claim 10, wherein the certificate is managed remotely.

14. The point of sale terminal of claim 1, wherein the first program instructions are configured to receive the first payment information from an external source.

15. The point of sale terminal of claim 1, wherein the fifth program instructions are configured to communicate the data representative of a payment transaction using one of TCP/IP, GPRS, CSD, SMS, and USSD communication protocol.

16. The point of sate terminal of claim 1, further comprising sixth program instructions configured to:
receive data indicative of a current location of the point of sale terminal; and
prevent the point of sale terminal from facilitating a payment transaction responsive to determining that the current location is not an approved location.

17. The point of sale terminal of claim 1, further comprising sixth program instructions configure to:
receive data indicative of an identification of the point of sale terminal;
prevent the point of sale terminal from facilitating a payment transaction responsive to determining that the identification of the mobile phone is not an approved identification.

18. The point of sale terminal of claim 1, further comprising at east one processor, at least one computer-readable tangible storage device, and program instructions stored on the at least one storage device for execution by the at least one processor, the program instructions configured to provide an interface between the integrated circuit card and the user interface.

19. A method for facilitating secure mobile payments comprising the steps of:
receiving first payment information, the payment information being indicative of a request to initiate a payment transaction;
activating a short distance contactless radio frequency interface;
receiving second payment information from the short distance contactless radio frequency interface;
generating payment transaction information based on the first payment information and the second payment information;
determining that the payment transaction information is valid; and
communicating the payment transaction information to a payment processing center.

20. The method of claim 19, further comprising the steps of storing the payment transaction information responsive to determining that a network for communicating the payment transaction information is unavailable.

21. The method of claim 19, wherein the step of receiving the first payment information indicative of a re quest to initiate a payment transaction comprises receiving the payment information from a remote server.

22. The method of claim 19, wherein the step of communicating payment transaction information comprises transmitting the payment transaction to a payment processing center.

23. The method of claim 19 further comprising the steps of
receiving data indicative of a current location of a mobile phone;
determining that a predefined set of approved locations comprise the current location; and
approving a payment transaction responsive to determining that the current location is an approved location.

24. The method of claim 23, further comprising the step of rejecting a payment transaction responsive to determining that the current location is not an approved location.

25. The method of claim 19, further comprising the steps of:
receiving data indicative of an identification of a host mobile phone;
determining that the host mobile phone is not an approved mobile phone; and
preventing the host mobile phone from facilitating a payment transaction responsive to determining that the host mobile phone is not an approved mobile phone.

26. A smart card for facilitating payment transactions in a hosting mobile computing device, the smart card comprising:
at least one processor;
at least one computer-readable tangible storage device; and
program instructions stored on the at least one storage device for execution by the at least one processor, the program instructions comprising:
first program instructions configured to receive a notification to initiate a payment transaction;
second program instructions configured to activate an NFC antenna;
third program instructions configured to receive data representative of first payment information via an interface of the hosting mobile computing device;
fourth program instructions configured to receive data representative of second payment information via the NFC antenna; and
fifth program instructions configured to communicate data representative of a payment transaction comprising the first payment information and the second payment information.

27. The smart card of claim 26, wherein the smart card comprises the NFC antenna.

28. The smart card of claim 26, the program instructions further comprising sixth program instructions configured to encrypt and store data representative of a payment transaction for future processing.

29. The smart card of claim 26, wherein the second program instructions are configured to activate an NFC antenna external to the smart card.

30. The smart card of claim 26, further comprising sixth program instructions configured to:
receive data indicative of a current location of a mobile phone associated with the smart card; and
prevent the smart card from facilitating a payment transaction responsive to determining that the current location is not an approved location.

31. The smart card of claim 26, further comprising sixth program instructions configure to:
receive data indicative of an identification of the mobile computing device;
prevent the smart card from facilitating a payment transaction responsive to determining that the identification of the mobile computing device is not an approved identification.
